(19) United States
(12) Patent Application Publication
(10) Pub. No.: US 2011/0055742 A1
(43) Pub. Date: Mar. 3, 2011

(54) CONTEXT ARRANGEMENT METHOD, CONTEXT ARRANGEMENT PROGRAM AND INFORMATION DISPLAY DEVICE

(75) Inventor: Masayuki TOMONO, Funabashi (JP)

(73) Assignee: ACCESS CO., LTD., Tokyo (JP)

(21) Appl. No.: 12/868,671

(22) Filed: Aug. 25, 2010

(30) Foreign Application Priority Data
Aug. 26, 2009 (JP) 2009-195283

(51) Int. Cl. G06F 3/048

(52) U.S. Cl. 715/766; 715/810

(57) ABSTRACT

A context arrangement method, comprising: an operation input step of accepting an input of an operation with respect to a selection target embedded in contents on a display screen; a context arrangement step of arranging a context at a position corresponding to the input of the operation in a virtual display space which is larger than an area in which the contents are displayed; and a drawing step of drawing display data of the selection target in the arranged context by a background processing.

### CROSS REFERENCE TO RELATED APPLICATIONS

This application claims priority of Japanese Patent Application No. 2009-195283, filed on Aug. 26, 2009. The entire subject matter of the application is incorporated herein by reference.

### BACKGROUND

The present invention relates to a context arrangement method, a context arrangement program and a context display device suitable for enabling a user to select, by an intuitive operation, a context arranged in a virtual display space which is larger than a standard display area.

In a general information terminal, a viewer for browsing an electronic file, such as an image or a document, and an application having a content browsing function, such as a Web browser for browsing Web contents, are installed. An application of this type is configured such that, when a link embedded in contents is selected, the application generates a view of contents of a link target and displays the view on a screen. Depending on the type of descriptions of the link, another application is called, and a view of contents of the link target is generated and displayed by the called application on the screen.

Applications having the content browsing function are constantly required to have intuitive operability. In each of U.S. Pat. No. 6,313,853 (hereafter, referred to as U.S. Pat. No. 6,313,853) and U.S. Patent Application Publication No. 2006/0101354 (hereafter, referred to as US 2006/0101354), an example of a concrete configuration of an application trying to realize intuitive operability is described. For example, an application described in U.S. Pat. No. 6,313,853 is configured such that when a selection target is dragged to a predetermined zone, a process associated with the zone, such as storing or moving of a selection target is executed so that operability can be enhanced through visual memory of a user.

Incidentally, in the application described in U.S. Pat. No. 6,313,853, when a link is selected, contents of a link target are displayed at the front on the screen, and contents of a link source which have already been displayed are placed at the back on the screen and are hidden.

Depending on the type of an information terminal, an application installation type where a view of a link source is wiped out may be employed in consideration of resources of the information terminal. That is, regarding the application described in U.S. Pat. No. 6,313,853, since, when a link is selected, onscreen representation of the contents of the link source is suspended, thereby causing an inconvenience the user is not able to continuously browse the contents of the link source.

On the other hand, the application described in US 2006/0101354 is configured such that, when a link displayed in a lower screen is dragged in a direction toward an upper screen, a view of contents of a link target is arranged and displayed on the upper screen. Since representation of the contents on the lower screen is not suspended, the user is able to continue to browse the contents of the link source. However, the application described in US 2006/0101354 is configured based on the premise that the information terminal has a two-screen structure, and therefore the displaying scheme of the application can not be applied to a general information terminal (not having two screens).

### SUMMARY

The present invention is advantageous in that it provides a context arrangement method, a context arrangement program and a context display device suitable for enabling a user to intuitively recognize a location of a view of contents of a link target while continuing representation of contents of a link source.

According to an aspect of the invention, there is provided a context arrangement method, comprising: an operation input step of accepting an input of an operation with respect to a selection target embedded in contents on a display screen; a context arrangement step of arranging a context at a position corresponding to the input of the operation in a virtual display space which is larger than an area in which the contents are displayed; and a drawing step of drawing display data of the selection target in the arranged context by a background processing.

Since the display data of the selection target is drawn by a background processing, onscreen representation of the contents continues. Since displaying of the contents is not interrupted by a link selection, the user is able to check, at a desired timing, a link target which has already been selected. Checking can be made smoothly because the display data has already drawn. The display data is arranged at the position corresponding to the input of the operation. Since the user can memorize the position of the display data in relation to the user operation (gesture) conducted by the user, the user is able to intuitively recognize the position of the display data in the virtual display space.

According to another aspect of the invention, there is provided a computer readable medium having computer readable instruction stored thereon, which, when executed by a processor of a computer, configures the processor to perform: an operation input step of accepting an input of an operation with respect to a selection target embedded in contents on a display screen; a context arrangement step of arranging a context at a position corresponding to the input of the operation in a virtual display space which is larger than an area in which the contents are displayed; and a drawing step of drawing display data of the selection target in the arranged context by a background processing.

Since the display data of the selection target is drawn by a background processing, onscreen representation of the contents continues. Since displaying of the contents is not interrupted by a link selection, the user is able to check, at a desired timing, a link target which has already been selected. Checking can be made smoothly because the display data has already drawn. The display data is arranged at the position corresponding to the input of the operation. Since the user can memorize the position of the display data in relation to the user operation (gesture) conducted by the user, the user is able to intuitively recognize the position of the display data in the virtual display space.

According to another aspect of the invention, there is provided an information display device, comprising: an input unit configured to accept an input of an operation with respect to a selection target embedded in contents on a display screen; a context arrangement unit configured to arrange a context at a position corresponding to the input of the operation in a virtual display space which is larger than an area in which the contents are displayed; and a drawing unit configured to draw display data of the selection target in the arranged context by a background processing.

Since the display data of the selection target is drawn by a background processing, onscreen representation of the contents continues. Since displaying of the contents is not interrupted by a link selection, the user is able to check, at a desired timing, a link target which has already been selected. Checking can be made smoothly because the display data has already drawn. The display data is arranged at the position corresponding to the input of the operation. Since the user can memorize the position of the display data in relation to the user operation (gesture) conducted by the user, the user is able to intuitively recognize the position of the display data in the virtual display space.

### BRIEF DESCRIPTION OF THE ACCOMPANYING DRAWINGS

FIG. 1 illustrates a general outer appearance of a terminal device according to an embodiment of the invention.

FIG. 2 is a block diagram illustrating a general configuration of the terminal device.

FIG. 3 is a flowchart illustrating a process executed on the terminal device when an application is invoked.

FIGS. 4A and 4B are explanatory illustrations for explaining the relationship between a virtual desktop space configured by an image buffer and a display screen area of a display.

FIG. 5 is a flowchart illustrating a process executed when a link is selected on the terminal device.

FIG. 6 is an explanatory illustration for explaining the flowchart shown in FIG. 5 in regard to the layout of the context in the virtual desktop space.

FIGS. 7A and 7B are explanatory illustrations for explaining the flowchart shown in FIG. 5 in regard to the layout of the context in the virtual desktop space.

FIGS. 8A and 8B are explanatory illustrations for explaining the flowchart shown in FIG. 5 in regard to the layout of the context in the virtual desktop space.

FIG. 9 illustrates an example of a layout of a context in a first variation of the embodiment.

FIG. 10 is an explanatory illustration for explaining a process for avoiding overlapping of contexts in accordance with a second variation of the embodiment.

### DETAILED DESCRIPTION OF THE EMBODIMENTS

Hereinafter, an embodiment according to the invention are described with reference to the accompanying drawings.

First of all, terms used in this specification are defined below:

Contents: a group of information including video, an image, sound, a document, data such as a work sheet or a combination thereof to be browsed by a user, to be transmitted through a network (various types of networks including a mobile communication network of a mobile communication carrier, an intranet and the Internet) or is stored locally in a device.
Web contents: a form of contents. The Web contents are a group of information transmitted through a network.
Web page: a form of Web contents. The Web page represents the entire contents to be displayed when a user designates an URI (Uniform Resource Identifier). That is, the Web page represents the entire contents which can be displayed by scrolling onscreen representation on a display. The Web page includes not only a Web page being browsed online but also a Web page being browsed offline. The Web page being browsed offline includes, for example, a page which is cached by a browser after having been received from the Internet, or a page stored, for example, in a local folder of a terminal device in an mht format. The Web page includes various types of information (Web page data), such as, HTML document, XHTML document, an image file, sound data, etc.
Window: a function of preparing a separate screen (a display area) in a display screen and displaying contents in the separate screen, or such a display area having, for example, a rectangular shape.
Context: a context is a unit of use history of an application, and corresponds to a window or a tab with regard to a Web browser.
View: a context to be presented to a user, or display data generated as a result of an operation of an application.

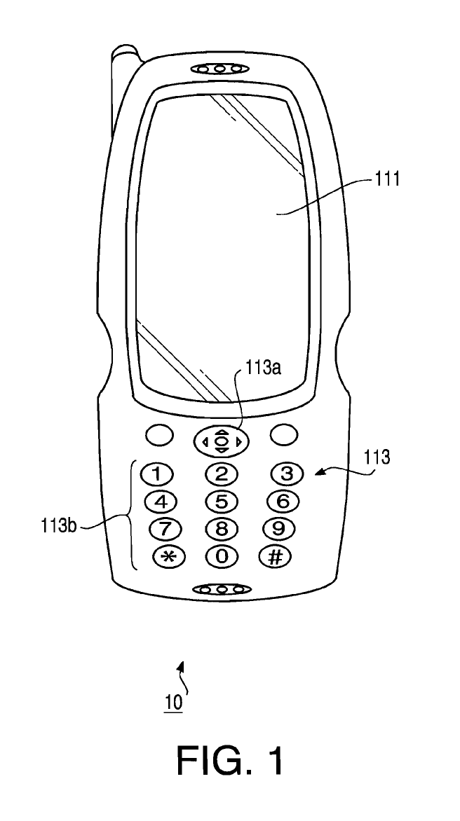

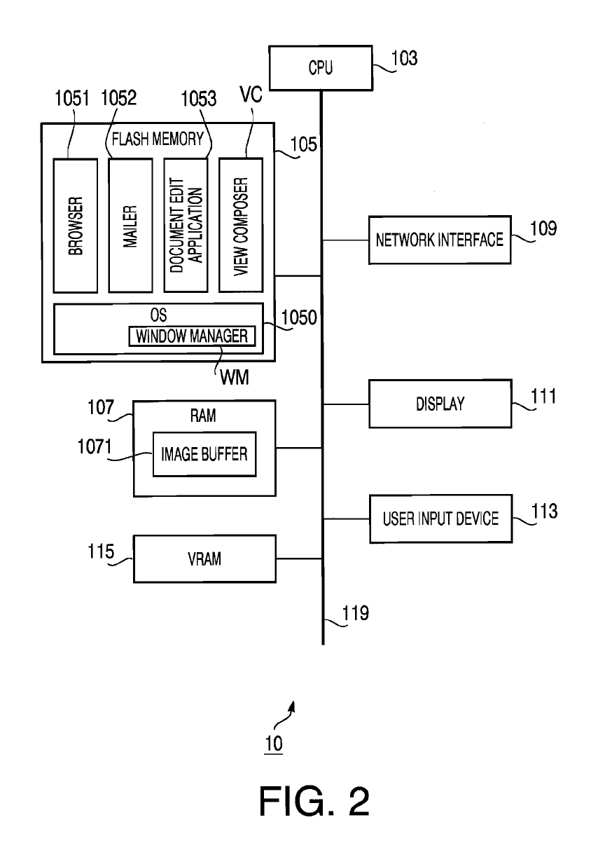

FIG. 1 illustrates a general outer appearance of a terminal device 10 according to the embodiment of the invention. FIG. 2 is a block diagram illustrating a general configuration of the terminal device 10. Although the terminal device 10 according to the embodiment is configured as a mobile phone, the present invention may also be implemented on various types of terminals, such as, a PDA, a PND (Portable Navigation Device), a PHS (Personal Handy Phone System), a portable game machine, a home appliance with a display panel, a desktop PC, a laptop PC, etc., on which an application having a content browsing function is installed. As shown in FIG. 1, the terminal device 10 according to the embodiment is configured as a so-called straight type mobile phone which holds a display 111 and a user input device 113 with an integrally formed body. However, the terminal device 10 may be a mobile phone having another structure, such as, a folding type, a rotational biaxial hinge type, a cycloid type or a swing type.

As shown in FIG. 2, the terminal device 10 includes a CPU (Central Processing Unit) 103 which totally controls the entire device 10. Each of the components configuring the terminal device 10 is connected to the CPU 103 via a system bus 119. The components configuring the terminal device 10 include a flash memory 105, a RAM (Random Access Memory) 107, a network interface 109, the display 111, the user input device 113, and a VRAM (Video Random Access Memory) 115. The system bus 119 includes a power line as well as data lines. Power is supplied to the various components in the terminal device 10, such as the CPU 103, from a battery (not shown) via the system bus 119.

When the terminal device 10 is turned ON, the CPU 103 executes necessary access to hardware components via the system bus 119. Immediately after power ON of the terminal device 10, the CPU 103 accesses the flash memory 105 to read an OS (Operating System) 1050, loads the OS 1050 into the RAM 107, and starts the OS 1050. In the flash memory 105, various types of applications including a browser 1051, a mailer 1052 and document edit software 1053 are installed. Each application operates under control of the OS 1050 which manages resources and processes.

As the user input device 113, the terminal device 10 is provided with a 5-way key 113a and a ten-key 113b. The 5-way key 113a is a combination key including four direction keys (upward, downward, left and right direction keys) and an Enter-key. When a key operation is conducted by the user through the user input device 113, a signal corresponding to the key operation is input to the CPU 103. By executing a process corresponding to the input signal through the CPU 103, various types of functions, such as Web browsing, are executed on the terminal device 10. The user is able to scroll the Web contents being browsed on a display screen (display 111) by operating either of the 5-way key 113a and the ten-key 113b. Furthermore, by operating the 5-way key 113a or the ten-key 113b, it is possible to select a form or a link embedded in the contents.

It should be noted that the user input device 113 is not limited to a mechanical key, such as the 5-way key 113a and the ten-key 113b. The user input device 113 may be configured by another type of key input device, such as a membrane key or a touch panel. The user input device 113 may be configured by appropriately combining various types of keys, such as a mechanical key, a membrane key and a touch panel. Furthermore, the user input device 113 may be an operation terminal (e.g., a remote controller) provided separately from the terminal device 10.

If the user input device 113 is configured by a touch panel, an operation screen providing operation keys is integrated with the display 111 or is provided separately from the display 111. In the former case, the display 111 itself is configured with a touch panel. In the latter case, the terminal device 10 has two screens, i.e., the display 111 and an operation touch panel. Furthermore, in the latter case, whether to configure the display 111 with a touch panel is determined in accordance with design specifications. When the display 111 is configured with a touch panel, intuitive operability, such as command input by pen touching or finger touching on operation keys arranged on the display screen, scrolling by a flicking operation (a sweeping motion of a finger on the display screen) and zooming-in/zooming-out by a pinching operation (widening or narrowing an interval between two fingers on the display screen), can be achieved.

A component other than a mechanical key, a membrane key and a touch panel may be mounted as a part of the user input device 113. As examples of such a component, a gyro-sensor, an acceleration sensor and a jerk sensor are named. In this case, a tilting angle, an angular velocity, an acceleration, and a jerk (a time rate of change of an acceleration) are detected based on outputs of the sensors, so that scrolling responsive to detection results can be achieved.

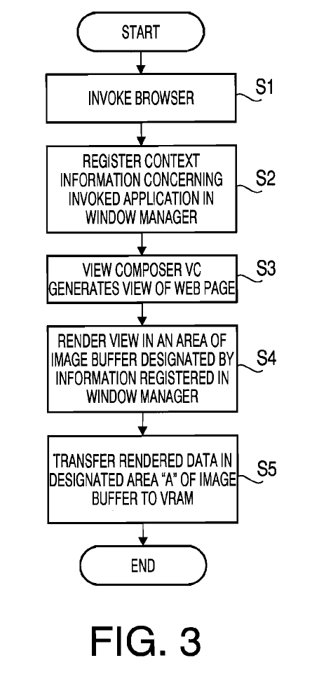

FIG. 3 is a flowchart illustrating a process executed on the terminal device 10 when an application is invoked. Let us consider the browser 1051 as an example of an application invoked according to the process shown in FIG. 3. In the following explanation and drawings, each processing step is abbreviated as “S”.

When the OS 1050 receives input of a command instructing invocation of the browser 1051, the OS 1050 loads the browser 1051 into the RAM 107 to execute the browser 1051 on the OS 1050 (S1). The invoked browser 1051 generates a request message complying with HTTP (Hypertext Transfer Protocol), accesses the designated URL (Uniform Resource Locator), and downloads resources such as a Web page.

As a part of the functions of the OS 1050, a window manager WM which manages arrangement and outer appearances of contexts (e.g., a window which is a rectangular area for displaying a view in the case of the browser 1051) is incorporated into the OS 1050. In the window manager WM, information, including an ID of a context for displaying a view of contents, an application (i.e., the browser 1051) corresponding to the context, and a layout of the context in a virtual desktop space, is registered (S2). The window manager WM manages the context in the virtual desktop space based on the registered context information. Hereafter, the registered context information is frequently referred to as management information. It should be noted that information concerning the layout of the context (hereafter, frequently referred to as layout information) includes a coordinate of the upper left corner of the context and a size of the context calculated by a view composer VC (which is described later). The window manager WM is not limited to a general-purpose module incorporated into the OS 1050, and may be configured as a dedicated module incorporated into each application.

In the flash memory 105, the view composer VC for generating display data as a operation result of the context has been installed. The view composer VC calls, from the browser 1051, a library necessary for generating a view of a downloaded Web page, executes parsing of the markup document or generation of a DOM (Document Object model) tree and a layout tree, and generates a view of the Web page (S3). It should be noted that, although the view composer VC is a separate component to be shared by the plurality of types of applications, in another embodiment the view composer VC may be configured as a module incorporated in to each application.

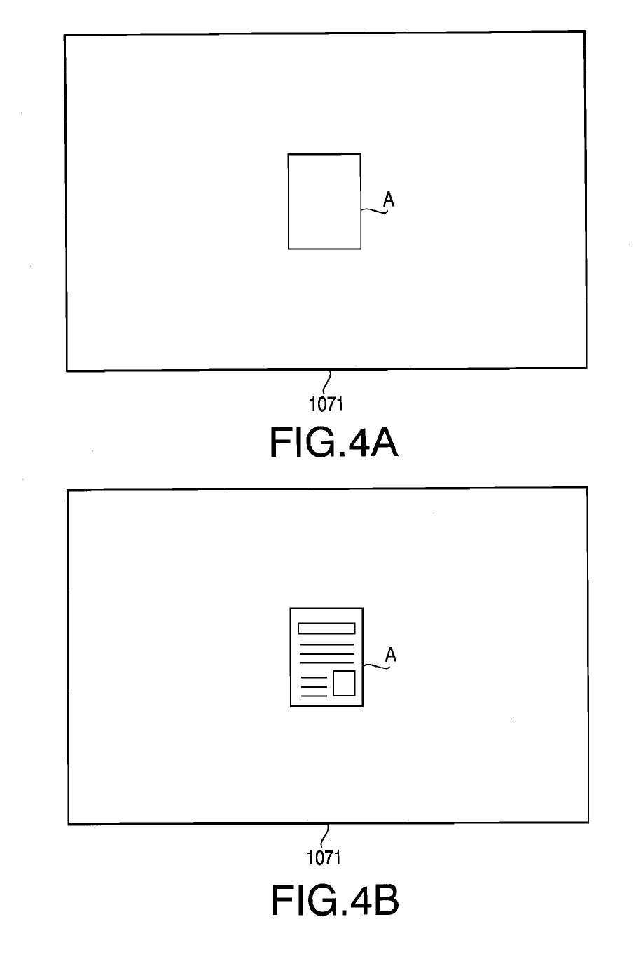

An image buffer 107 is provided in a predetermined area of the RAM 107. The image buffer 1071 corresponds to the virtual desktop space, and constitutes a wide image area wider than the screen size (resolution) of the display 111. FIGS. 4A and 4B are explanatory illustrations for explaining the relationship between the virtual desktop space configured by the image buffer 1071 and the display screen area of the display 111. On the display 111, only a rendering result of a designated area A (see FIG. 4A) of the image buffer 1071 is displayed. The position of the designated area A can be defined arbitrarily by a user operation in the image buffer 1071.

The view generated in S3 is rendered into an area in the image buffer 1071 designated by the layout information of the context registered in the window manager WM (S4). The layout information designates the coordinate of the upper left corner of the designated area A as a position of the upper left corner of the context, and designates the size of the designated area A as a size of the context. Therefore, the view corresponding to the context is rendered into the area in the image buffer 1071 coinciding with the designated area A as shown in FIG. 4(B). Although, in the following, the size of the context is described as being the same size as the designated area A for convenience of explanation, the size of the context is essentially defined depending on contents and display settings.

The VRAM 115 is a memory for storing data directly displayed on the display 111, and has an image area corresponding to the screen size of the display 111. To the VRAM 115, data rendered in the designated area A of the image buffer 1071 is transferred (S5). By transferring the rendering result to the VRAM 115, the Web page of the designated URL is displayed on the display 111.

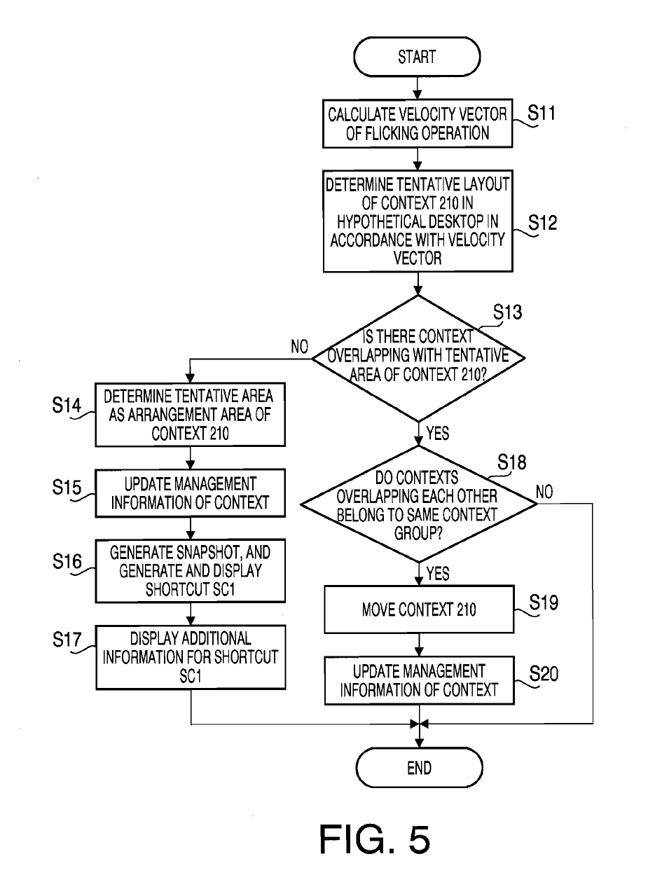

In the Web page displayed on the display 111, a plurality of links are embedded as in the case of a general Web page. Next, a process to be executed on the terminal device 10 when a link is selected is explained. FIG. 5 is a flowchart illustrating the above described process.

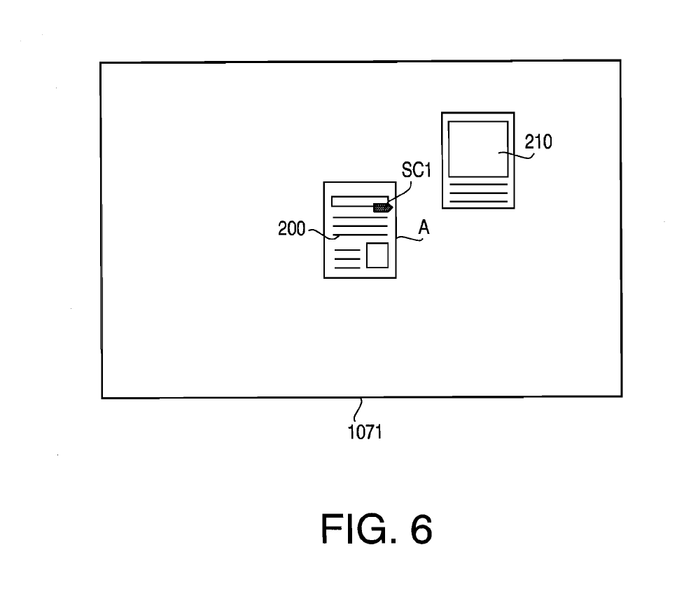

FIGS. 6-8 are explanatory illustrations for explaining the flowchart shown in FIG. 5 in regard to the layout of the context in the virtual desktop space. In the following, a numerical symbol 200 is assigned to the context corresponding to the view generated by the process shown in FIG. 3. Hereinafter, a context of a link source seen from a context of a link target is referred to as a parent context, and a context of a link target seen from a context of a link source is referred to as a child context.

In this embodiment, to realize intuitive operability, a user is required to conduct a flicking operation with respect to a selected link. Specifically, the user sweeps the user's finger while touching the link displayed on the display screen. To the window manager WM, a sensing result of the touch panel is input. The window manager WM calculates the direction and velocity (velocity vector) of the flicking operation based on the sensing result (S11). The flicking operation may be replaced with a dragging operation where a mouse or a stylus is dragged in a desired direction in a state where the link is designated.

The window manager WM tentatively determines a layout of a context 210 (which is a display area of a view of contents of the link target) in the virtual desktop space in accordance with the velocity vector of the flicking operation (S12). Specifically, the coordinate of the upper left corner of the context 210 is moved to the position deviating from a start point defined as the coordinate of the upper left corner of the parent context 200, along a straight line extending in the same direction as that of the flicking operation, by a distance corresponding to the velocity of the flicking operation from the coordinate of the upper left corner of the parent context 200. For example, the distance between the start point and the tentative coordinate of the upper left corner of the context 210 is proportional to the velocity of the flicking operation. A tentative area of the context 210 is determined as a rectangular area whose upper left corner is equal to the tentative coordinate and whose size is equal to that of the designated area A.

In S13, the window manager WM refers to the management information of the context, and judges whether at least a part of the tentative area of the context 210 overlaps with another context. When there is no context overlaps with the tentative area of the context 210 as shown in FIG. 6 (S13: NO), the tentative area is determined as an arrangement area of the context 210 (S14).

In S15, the window manager WM updates the management information of the context. Specifically, the window manager WM registers information, such as, an ID of the context 210, an application (the browser 1051) corresponding to the context 210, and the layout of the context 210 in the virtual desktop space. Furthermore, the window manager WM registers information indicating that the context 200 and the context 210 are in a parent-child relation and belong to the same context group.

In step S16, the window manager WM asks the view composer VC to generate a snapshot of the contents of the link target, generates a shortcut SC1 used to cause transition of onscreen representation to the context 210, and displays the shortcut SC1 on the display 111. The shortcut SC1 is displayed at the display screen's edge position which is on a straight line extending, from the center of the display screen, in the direction of the flicking operation. The view composer VC calls a minimum number of libraries required for generating a snapshot from the application (i.e., the browser 1051) corresponding to the context 210, and executes a process for generating the snapshot by background processing.

In step S17, while the view composer VC executes the generation process for generating the snapshot by background processing, the window manager WM displays simple animation near the shortcut SC1 to indicate that the snapshot is being generated. In corporation with the view composer VC, the window manager WM displays, alongside the shortcut SC1, a title of the contents of the link target extracted from a title element, for example, in the parsing process. When generation of the snapshot is finished, the view composer VC discards data other than the snapshot obtained in the generation process. If resources of the terminal device 10 are rich, discarding the data is not necessary. It should be noted that, when a link is void or a link requires invocation of an untreatable application, a message indicating that a snapshot can not be generated is displayed on the display screen.

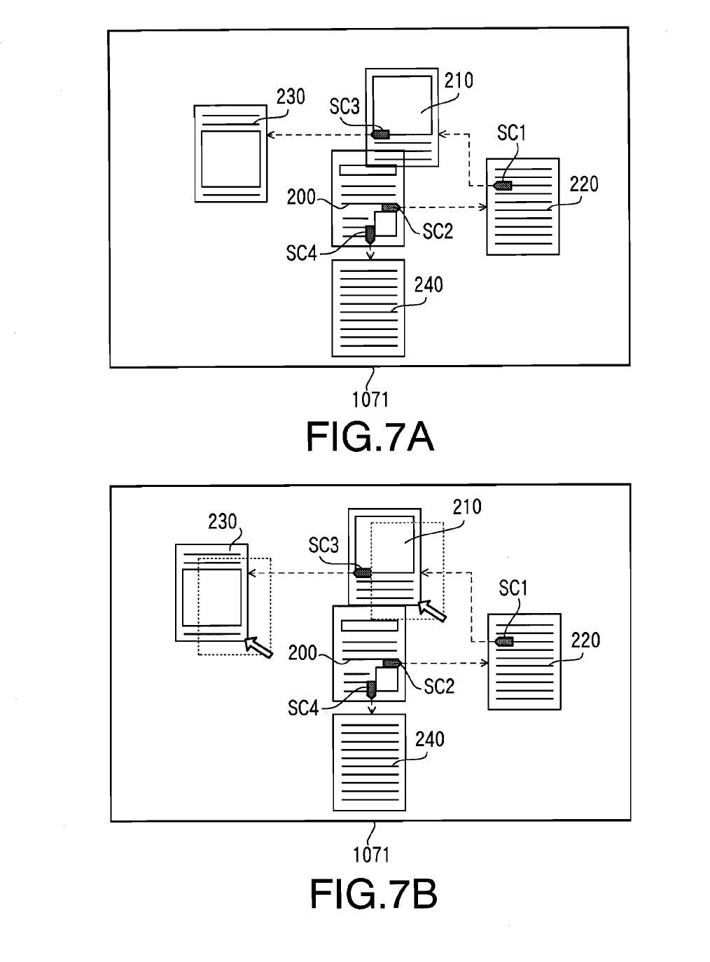

When a context (context 200 in FIG. 7A) overlapping with the tentative area of the context 210 exists as shown in FIG. 7A (S13: YES), the CPU 103 judges whether the context 210 and the context 200 belong to the same context group (S18).

A context 220 shown in FIGS. 7A and 7B is referred to by the shortcut SC2, and the parent context of the context 220 is the context 200. The context 210 shown in FIGS. 7A and 7B is referred to by the shortcut SC1, and the parent context of the context 210 is the context 220, and the context 210 corresponds to a grandchild of the context 200. A context 230 shown in FIGS. 7A and 7B is referred to by a shortcut SC3, and the parent context of the contest 230 is the contest 210. A context 240 shown in FIGS. 7A and 7B is referred to by a shortcut SC4, and the parent context of the context 240 is the context 200. In FIGS. 7A and 7B, for convenience of explanation, a parent-child relation is indicated by an arrow of a dashed line. The contexts 200, 210 and 220 are in a parent-child-grandchild relation, and the window manager WM manages the contexts 200, 210 and 220 as contexts belonging to the same context group. Since the contexts 200 and 210 belong to the same context group (S18: YES), the window manager WM moves the context 210 away from the context 200 by a minimum distance required to avoid overlapping between the contexts 200 and 210 while maintaining the relative direction (i.e., the directional relationship) between the context 210 and the context 220 which are in a parent-child relation (S19).

In the layout information, a coordinate of a context is managed as a relative coordinate with respect to a coordinate of a parent context. Therefore, as shown in FIG. 7B, the context 230 whose parent context is the context 210 moves together with the context 210 while maintaining the relative position with respect to the context 210. In response to movement of the contexts 210 and 230, the window manager WM updates the management information of the context (the layout information of the contexts 210 and 230) (S20).

There is a case where, as a result of movement of the contexts 210 and 230, the context 210 or the context 230 overlaps with another context. When a context with which the context 210 or 230 overlaps belongs to the same context group to which the context 210 or the context 230 belongs (S18: YES), the window manager WM executes a process for avoiding overlapping between the context and the context 210 or 230 similarly to the process of S19.

Depending on the type of a link, there are contents referred to by an application other than a browser, such as a mailer 1052 or document editing software 1053. That is, there is a case where applications associated with contexts are different from each other. If applications respectively associated with the context 200 and the context 220 are different from each other, the window manager WM judges the context 220 to be positioned at a boundary of a new context group, and manages descendant contexts of the context 220, as contexts belonging to a context group which is different from the context group of the context 200. That is, there is a case where, although the contexts 210 and 230 are descendants of the context 200, the contexts 210 and 230 belong to a context group which is different from the context group of the context 200. In this case, the steps S19 and S20 are not processed (S18: NO). On the display screen, only contexts belonging to the same context group as that of a selected context (e.g., a context on which is a focus is placed) are displayed. When the context 200 is selected, the view of the context 210 overlapping with the contest 200 is not displayed. That is, even if contexts overlapping with each other exist in the layout information, overlapping is not represented on the display screen, thereby preventing browsing by the user from being obstructed. It should be noted that, for a context having a parent context or a descendant context belonging to a different context group, information indicating such a fact may be additionally displayed.

In this embodiment, when a link is selected on the context 200, displaying of the view of the context 200 continues and a view of the selected link is generated successively by background processing. Since displaying of the view being browsed continues and is not interrupted by a link selection, the user is able to check, at a desired timing, a link target which has already been selected. Since generation of a view of a link target and invocation of a target application are executed by background processing, onscreen representation transits smoothly to the link target. Furthermore, a shortcut to the link target is located, on the display screen, at a position corresponding to a user's gesture (e.g., the direction and velocity of a flicking operation or a dragging operation). The user is able to memorize a relationship between a shortcut and a link while visually linking the link and the shortcut corresponding to the user's gesture which the user has made when selecting the link. Therefore, the user is able to intuitively select a shortcut to a desired link in accordance with the user's visual memory, and to cause the onscreen representation to transit to the desired link.

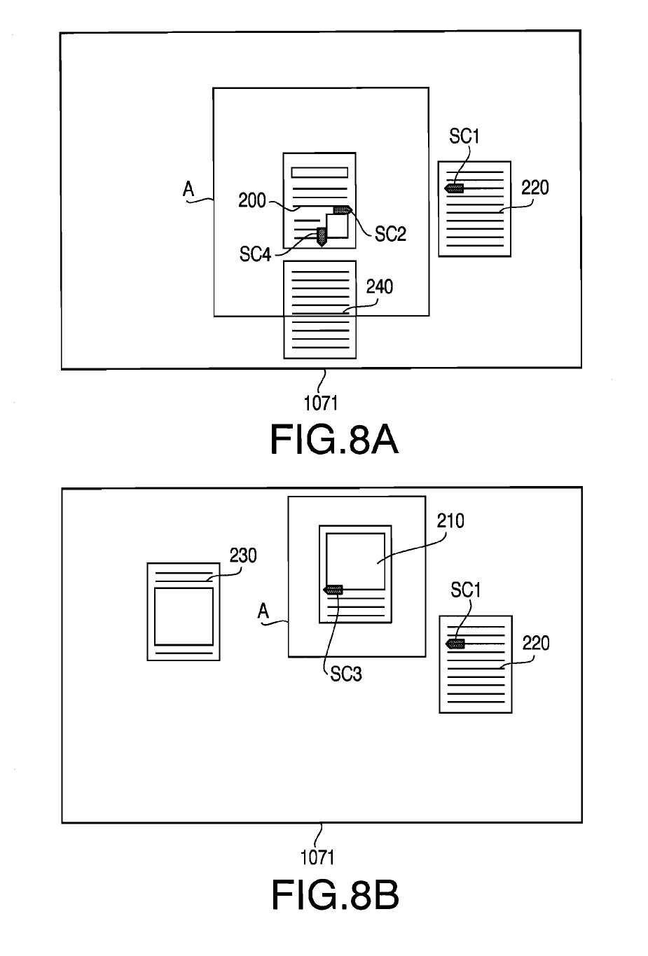

By conducting a zooming out operation, the user is able to display an area wider than a standard (initial) display screen area (e.g., the designated area A shown in FIG. 6). Let us consider the case where contexts are managed in a layout shown in FIG. 7A, the contexts 200, 220 and 240 belong to a first context group, and the contexts 210, 220 and 230 belong to a second context group which is different from the first context group. When the context 200 is selected, the window manager WM displays only contexts belonging to the first context group. As shown in FIG. 8A, even if the display area is enlarged by a zooming out operation, contexts other than the contexts belonging to the first context group are not displayed. When the context 210 is selected, only contexts belonging to the second context group are displayed. As shown in FIG. 8B, even if the display area is enlarged by a zooming out operation, contexts other than the contexts belonging to the second context group are not displayed.

In the above described example shown in FIGS. 8A and 8B, only contexts belonging to the context group (hereafter, referred to as a selected context group) having the selected context are displayed, and contexts not belonging to the selected context group are not displayed. However, all of the contexts belonging to the selected context group and the contexts not belonging to the selected context group may be displayed in a state where the contexts belonging to the selected context group are distinguishable from the contexts not belonging to the selected context group (e.g., in a state where the contexts belonging to the selected context group are highlighted, and the contexts not belonging to the selected context group are not highlighted or in a state where the contexts belonging to the selected context group are distinguished from the contexts not belonging to the selected context group by gray-scale representation).

By looking down the virtual desktop space by conducting the zooming out operation, the user is able to easily recognize the context which has high relevance with respect to a selection target. In addition, the user is able to visually identify the position at which the link target is placed. Furthermore, the user is able to cause the onscreen representation to transit to a desired context by conducting scrolling or panning of the display area.

Although the present invention has been described in considerable detail with reference to certain preferred embodiments thereof, other embodiments are possible.

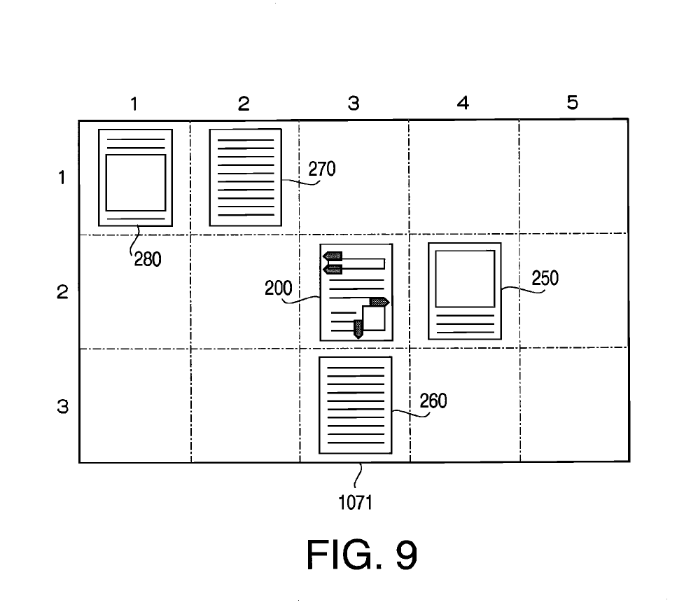

For example, a context is not required to be arranged at a position precisely reflecting a user's gesture, but may be arranged at a position approximately reflecting a user's gesture. Let us consider the case (a first variation) where the virtual desktop space is managed in a condition where the virtual desktop space is divided into a plurality of areas by grids (i, j) as shown in FIG. 9. When the user sweeps rightward a link arranged in grid (2, 3) of the context 200 by a flicking operation, a context 250 is arranged at grid (2, 4) which is the right-hand neighbor of grid (2, 3). On the other hand, when the user sweeps downward a link arranged in grid (2, 3) of the context 200 by a flicking operation, a context 260 is arranged at grip (3, 3) which is the downward neighbor of grid (2, 3). When the user sweeps, by a flicking operation, a link arranged in grid (2, 3) of the context 200, in an upper leftward direction, a context 270 is arranged at grid (1, 2) which is an upper leftward neighbor of grid (2, 3). When the user conducts a same flicking operation in an upper leftward direction, a context 280 is arranged at grid (1, 1) which is a left-hand neighbor of grid (1, 2). According to the above described first variation, a context is arranged at a position approximately reflecting the user's gesture, and overlapping of contexts does not occur. Therefore, there is no necessity to execute a judging process for judging whether overlapping of contexts occurs and to execute a process for avoiding overlapping of contexts.

There is a limit of the virtual desktop space, and therefore the number of contexts which can be arranged in the virtual desktop space is limited. Therefore, when the terminal device 10 runs short of space for arranging contexts, a message indicating that the terminal device 10 runs short of space for arranging contexts may be displayed on the display screen.

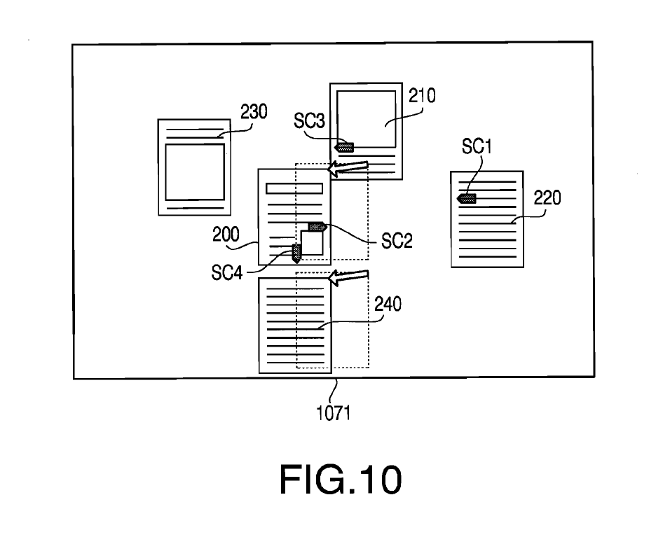

Hereafter, a second variation of the embodiment is described with reference to FIG. 10. FIG. 10 is an explanatory illustration for explaining a process for avoiding overlapping of contexts. Specifically, FIG. 10 illustrates a situation immediately after the context 210 whose parent context is the context 200 is generated as in the case shown in FIG. 7B. The contexts shown in FIG. 10 have the same parent-child relationship as that of FIG. 7A. According to the second variation, when overlapping of contexts occurs, a context corresponding to a latest user operation (e.g., a newly generated context or a moved context) is preferentially arranged at a position designated by the latest user operation, on the assumption that a newer user operation should be reflected more preferentially in the layout of contexts. Specifically, when the newly generated context 210 overlaps with the context 200, the window manager WM moves the context 200 away from the context 220 by a minimum distance for avoiding overlapping between the contexts 200 and 210, while maintaining a relative direction of the contexts 200 and 220 which are in a parent-child relation. In this case, although the context 240 moves together with the context 200 which is a parent context of the context 240, the context 220 does not move and the relative coordinate with respect to the parent contest 200 is updated. Similarly to the parent context 220, the context 210 also does not move, and the context 210 is fixed at the position designated by the user operation.

In step S16 in FIG. 5, in addition to generating a shortcut from a parent to a child (hereafter, referred to as a descendant shortcut) on the parent context, a shortcut from the child to the parent (hereafter, referred to as an ancestral shortcut) may be generated on the child context. That is, shortcuts may be generated in a two-way basis. The descendant shortcut and the ancestral shortcut may have different colors or different shapes so that the descendant shortcut and the ancestral shortcut can be visually distinguished with each other. For example, the descendant shortcut is formed to have a shape of an arrow pointing toward the periphery of the display screen as shown in each of FIGS. 6 to 10, and the ancestral shortcut may be formed to have a shape of an arrow pointing inversely on the display screen (i.e., pointing inward on the display screen).

When a particular gesture (e.g., long-pressing) is conducted on a shortcut, a snapshot corresponding to a shortcut target may be displayed temporarily in a small screen or in the entire display screen. In this case, from the snapshot associated with the descendant shortcut or the ancestral shortcut, the user is able to check display data of a parent context or a child context and to image and grasp the relationship between the contexts. When contents are wider than the display screen area and scrolling is possible or when display data is dynamically changed by a script, the display data of the context may be changed from the display data generated when generation of the context is requested. The display data of the context which can be checked tentatively may be data corresponding to current timing at which the shortcut is selected, or may be data corresponding to timing when generation of the context is requested. In the former case, since the terminal device 10 may generate a snapshot when the shortcut is generated, it is not necessary to generate in advance the snapshot and store the snapshot.

In a state where the display area has been enlarged by the zooming out operation, all of or a part of the contexts belonging to the same context group to which a context of a selection target context belongs may be deleted collectively by a user operation. Each context may be movable in the virtual desktop space by a dragging operation. When such a moving operation is conducted, an overlapping judgment process and an overlapping avoiding process are also executed. As described above, the layout of the context of the selection target can be changed freely in the state where the display area has been enlarged by the zooming out operation. Change of the display data following the above described change of the layout (e.g., change of the layout of the context belonging to the same context group, in conjunction with the context of the selection target) can automatically be updated.

Let us consider the case where a link, which is used to generate a new window by a window.open method of JavaScript® and to display contents of a designated URL, is selected. In this case, a child context is generated regardless of a fact that a dragging operation and a flicking operation are not conducted. In this case, the window manager WM refers to the management information of the context, calculates the position at which overlapping with another context does not occur and where the context is nearest to a parent contest, and places the child context at the calculated position. In order to enable the user to visually memorize the positional relationship between the parent context and child context, the following three steps may be executed in conjunction with the arranging process for the child context.

(1) Expand the display area to the extent that all the contexts in a context group to which the child context belongs can be looked down.
(2) Expand the display area to the extent that the positional relationship between the parent context and the child context can be recognized.
(3) Cause the onscreen representation to transit from the parent context to the child context.

It should be noted that, after the steps (1) to (3) have been processed, the selection target may be changed from the parent context to the child context. Afterward, transition of the screen transition to the parent context may be easily executed by utilizing the ancestral shortcut.

Hereafter, a general overview of the invention is provided. According to an aspect of the invention, there is provided a context arrangement method, comprising: an operation input step of accepting an input of an operation with respect to a selection target embedded in contents on a display screen; a context arrangement step of arranging a context at a position corresponding to the input of the operation in a virtual display space which is larger than an area in which the contents are displayed; and a drawing step of drawing display data of the selection target in the arranged context by a background processing.

In at least one aspect, the context arrangement step may include the steps of: calculating a direction and a velocity of one of a flicking operation and a dragging operation with respect to the selection target; and arranging the context such that the context is positioned away from the contents by a distance which is in proportion to the calculated velocity, and that a relative direction between the contents and the context becomes equal to the calculated direction.

In at least one aspect, the method may further include the steps of: generating a shortcut to cause a screen transition to the context; and arranging the shortcut at an edge portion in the display screen in accordance with the calculated direction.

In at least one aspect, the method may further include the step of: defining a context group to which the context belongs. In this case, the context arrangement step includes the steps of: detecting overlapping of contexts; judging whether the detected contexts overlapping each other belong to a same context group; and changing a relative positional relationship between the contexts judged to belong to the same context group so that the contexts do not overlap with each other.

In at least one aspect, the method may further include the step of displaying only contexts belonging to a same context group.

In at least one aspect, in the drawing step, a snapshot of the display data of the selection target may be drawn.

In at least one aspect, in the drawing step, only a function of an application required for drawing the snapshot of the display data of the selection target may be called and the drawing may be executed.

According to another aspect of the invention, there is provided an information display device, comprising: an input unit configured to accept an input of an operation with respect to a selection target embedded in contents on a display screen; a context arrangement unit configured to arrange a context at a position corresponding to the input of the operation in a virtual display space which is larger than an area in which the contents are displayed; and a drawing unit configured to draw display data of the selection target in the arranged context by a background processing.

In at least one aspect, the context arrangement unit may calculate a direction and a velocity of one of a flicking operation and a dragging operation with respect to the section target, and arrange the context such that the context is positioned away from the contents by a distance which is in proportion to the calculated velocity and that a relative direction between the contents and the context becomes equal to the calculated direction.

In at least one aspect, the information display device may further include: a shortcut generation unit configured to generate a shortcut to cause a screen transition to the context; and a shortcut arranging unit configured to arrange the shortcut at an edge portion in the display screen in accordance with the calculated direction.

In at least one aspect, the information display device may further include a context group defining unit configured to define a context group to which the context belongs. In this case, the context arrangement unit comprises: a detecting unit configured to detect overlapping of contexts; an attribute judgment unit configured to judge whether the contexts detected as overlapping each other belong to a same context group; and a position changing unit configured to change a relative positional relationship between the contexts judged to belong to the same context group so that the contexts do not overlap with each other.

In at least one aspect, the information display device may further include a context displaying unit configured to display only contexts belonging to a same context group.

In at least one aspect, the drawing unit may draw a snapshot of the display data of the selection target.

In at least one aspect, the drawing unit may call only a function of an application required for drawing the snapshot of the display data of the selection target, and execute the drawing of the display data.

What is claimed is:

1. A context arrangement method, comprising:
an operation input step of accepting an input of an operation with respect to a selection target embedded in contents on a display screen;
a context arrangement step of arranging a context at a position corresponding to the input of the operation in a virtual display space which is larger than an area in which the contents are displayed; and
a drawing step of drawing display data of the selection target in the arranged context by a background processing.

2. The context arrangement method according to claim 1,
wherein the context arrangement step comprises the steps of:
calculating a direction and a velocity of one of a flicking operation and a dragging operation with respect to the selection target; and
arranging the context such that the context is positioned away from the contents by a distance which is in proportion to the calculated velocity, and that a relative direction between the contents and the context becomes equal to the calculated direction.

3. The context arrangement method according to claim 2,
further comprising the steps of:
generating a shortcut to cause a screen transition to the context; and
arranging the shortcut at an edge portion in the display screen in accordance with the calculated direction.

4. The context arrangement method according to claim 1,
further comprising the step of:
defining a context group to which the context belongs,
wherein the context arrangement step comprises the steps of:
detecting overlapping of contexts;
judging whether the detected contexts overlapping each other belong to a same context group; and
changing a relative positional relationship between the contexts judged to belong to the same context group so that the contexts do not overlap with each other.

5. The context arrangement method according to claim 4, further comprising the step of displaying only contexts belonging to a same context group.

6. The context arrangement method according to claim 1, wherein, in the drawing step, a snapshot of the display data of the selection target is drawn.

7. The context arrangement method according to claim 6,
wherein, in the drawing step, only a function of an application required for drawing the snapshot of the display data of the selection target is called and the drawing is executed.

8. A computer readable medium having computer readable instruction stored thereon, which, when executed by a processor of a computer, configures the processor to perform:
an operation input step of accepting an input of an operation with respect to a selection target embedded in contents on a display screen;
a context arrangement step of arranging a context at a position corresponding to the input of the operation in a virtual display space which is larger than an area in which the contents are displayed; and
a drawing step of drawing display data of the selection target in the arranged context by a background processing.

9. The computer readable medium according to claim 8,
wherein the context arrangement step comprises the steps of:
calculating a direction and a velocity of one of a flicking operation and a dragging operation with respect to the selection target; and
arranging the context such that the context is positioned away from the contents by a distance which is in proportion to the calculated velocity, and that a relative direction between the contents and the context becomes equal to the calculated direction.

10. The computer readable medium according to claim 9,
the instruction further configures the processor to perform the steps of:
generating a shortcut to cause a screen transition to the context; and
arranging the shortcut at an edge portion in the display screen in accordance with the calculated direction.

11. The computer readable medium according to claim 8,
the instruction further configures the processor to perform the step of:
defining a context group to which the context belongs,
wherein the context arrangement step comprises the steps of:
detecting overlapping of contexts;
judging whether the detected contexts overlapping each other belong to a same context group; and
changing a relative positional relationship between the contexts judged to belong to the same context group so that the contexts do not overlap with each other.

12. The computer readable medium according to claim 11, the instruction further configures the processor to perform the step of displaying only contexts belonging to a same context group.

13. The computer readable medium according to claim 8, wherein, in the drawing step, a snapshot of the display data of the selection target is drawn.

14. An information display device, comprising:
an input unit configured to accept an input of an operation with respect to a selection target embedded in contents on a display screen;
a context arrangement unit configured to arrange a context at a position corresponding to the input of the operation in a virtual display space which is larger than an area in which the contents are displayed; and
a drawing unit configured to draw display data of the selection target in the arranged context by a background processing.

15. The information display device according to claim 14,
wherein the context arrangement unit calculates a direction and a velocity of one of a flicking operation and a dragging operation with respect to the section target, and arranges the context such that the context is positioned away from the contents by a distance which is in proportion to the calculated velocity and that a relative direction between the contents and the context becomes equal to the calculated direction.

16. The information display device according to claim 15, further comprising:
a shortcut generation unit configured to generate a shortcut to cause a screen transition to the context; and
a shortcut arranging unit configured to arrange the shortcut at an edge portion in the display screen in accordance with the calculated direction.

17. The information display device according to claim 14,
further comprising a context group defining unit configured to define a context group to which the context belongs,
wherein the context arrangement unit comprises:
a detecting unit configured to detect overlapping of contexts;
an attribute judgment unit configured to judge whether the contexts detected as overlapping each other belong to a same context group; and
a position changing unit configured to change a relative positional relationship between the contexts judged to belong to the same context group so that the contexts do not overlap with each other.

18. The information display device according to claim 17, further comprising a context displaying unit configured to display only contexts belonging to a same context group.

19. The information display device according to claim 14, wherein the drawing unit draws a snapshot of the display data of the selection target.

20. The information display device according to claim 19, wherein the drawing unit calls only a function of an application required for drawing the snapshot of the display data of the selection target, and executes the drawing of the display data.
